(19) United States
(12) Patent Application Publication
(10) Pub. No.: US 2009/0296066 A1
(43) Pub. Date: Dec. 3, 2009

(54) ILLUMINATION SYSTEM OF A MICROLITHOGRAPHIC PROJECTION EXPOSURE APPARATUS, AND DEPOLARIZER

(75) Inventor: Damian Fiolka, Oberkochen (DE)

Correspondence Address: FISH & RICHARDSON PC, P.O. BOX 1022, MINNEAPOLIS, MN, 55440-1022, US

(73) Assignee: CARL ZEISS SMT AG, Oberkochen (DE)

(21) Appl. No.: 12/540,107

(22) Filed: Aug. 12, 2009

Related U.S. Application Data
(63) Continuation of application No. 11/456,368, filed on Jul. 10, 2006.
(60) Provisional application No. 60/698,338, filed on Jul. 12, 2005.

(51) Int. Cl. G03B 27/72; G02B 27/28

(52) U.S. Cl. 355/71; 359/495

(57) ABSTRACT

The disclosure relates to an exposure system of a microlithographic projection exposure apparatus that includes a light source which produces substantially linearly polarised light which is propagated along a light propagation direction. The system also includes a light mixing system and an effectively depolarising system which is arranged upstream of the light mixing system in the light propagation direction. The effectively depolarising system causes a variation in the polarisation direction over the light beam cross-section such that the light mixing effected by the light mixing system substantially produces light without a polarisation preferred direction in an illumination plane, wherein the effectively depolarising system has at least one element of optically active crystal material with at least one portion extending substantially wedge-shaped in the light propagation direction, wherein the optical crystal axis is substantially parallel to the light propagation direction. The disclosure also provides a depolarizer which can be used in an illumination system.

### CROSS-REFERENCE TO RELATED APPLICATION

This application is a continuation of, and claims benefit under 35 U.S.C. § 120, to U.S. application Ser. No. 11/456,368, Jul. 10, 2006, which claims priority under 35 U.S.C. §119(e)(1) of U.S. Provisional Application No. 60/698,338, filed Jul. 12, 2005. The contents of these applications are hereby incorporated by reference in its entirety.

### FIELD OF THE INVENTION

The disclosure relates to an illumination system of a microlithographic projection exposure apparatus. In particular the disclosure relates to an illumination system in which substantially unpolarised light is wanted and in which a preferred direction of polarisation can be substantially or completely eliminated. The invention also concerns a depolarizer that may be used in such an illumination system.

### BACKGROUND

In an illumination system of a microlithographic projection exposure apparatus it is desirable for many uses to produce light which is as unpolarised as possible, for which purpose it is necessary for the linearly polarised light from the laser source to be depolarised. For that purpose it is known in particular to use what is referred to as a Hanle depolariser for example in the proximity of the first field plane of the illumination system. A Hanle depolariser includes at least a first wedge plate of birefringent material which is transparent for light of the working wavelength, and typically also a second wedge plate which compensates for the beam deflection of the first wedge plate and which is made from birefringent or non-birefringent material which is transparent to light of the working wavelength.

The first wedge plate of the Hanle depolariser is usually arranged in such a way that the angle between the optical crystal axis of the birefringent material and the vibration direction of the electrical field strength vector of the linearly polarised light coming from the laser source is substantially 45°.

It has been found however that in practice, after passing through the Hanle depolariser, the light still involves a residual degree of polarisation which is to be attributed to the fact that the above orientation of linear polarisation upon entering the Hanle depolariser is not set exactly but only with a certain tolerance. It is further found that the residual degree of polarisation exhibits a delicate dependency on that orientation which is given by

$$P = {cos ( \frac{π}{4} dA )}^{2} - {sin ( \frac{π}{4} - dA )}^{2} \qquad ( 1 )$$

wherein dA specifies the angular deviation from the foregoing reference angle of 45° between the optical crystal axis in the birefringent wedge plate and the vibration direction of the entry polarisation. By way of example in the case of an angular deviation dA ≈1° the residual degree of polarisation P is about 3.5%, the preferred direction of that residual polarisation being along the optical crystal axis.

To overcome that problem the attempt can be made to set the orientation of the linear entry polarisation relative to the optical crystal axis as accurately as possible, for which purpose it is possible to use for example a rotatable polariser or a rotatable lambda/2 plate. It will be noted however that in that case on the one hand measurement of the residual degree of polarisation or calibration of the position of the depolariser and in addition good reproducibility of that position when moving into and out of the beam path is required.

### SUMMARY OF THE INVENTION

In certain embodiments, an illumination system of a microlithographic projection exposure apparatus is provided in which a preferred direction of polarisation can be substantially or completely eliminated.

In one aspect, the invention generally features an illumination system of a microlithographic projection exposure apparatus. The illumination system includes: a) a light source which produces substantially linearly polarised light which propagates along a light propagation direction; b) a light mixing system; and c) an effectively depolarising system. The light mixing system is between the effectively depolarising system and the light source along the light propagation direction. During use of the illumination system, the effectively depolarising system causes a variation in the polarisation direction over the light beam cross-section in such a way that the light mixing effected by the light mixing system produces substantially light without a polarisation preferred direction in an illumination plane. The effectively depolarising system includes at least one element of optically active crystal material with at least one portion extending substantially wedge-shaped in the light propagation direction, wherein the optical crystal axis is substantially parallel to the light propagation direction.

In another aspect, the invention generally features an illumination system of a microlithographic projection exposure apparatus. The illumination system includes: a) a light source which produces substantially linearly polarised light which propagates along a light propagation direction; b) a light mixing system; and c) an effectively depolarising system. The light mixing system is between the effectively depolarising system and the light source along the light propagation direction. During use of the illumination system, the effectively depolarising system causes a variation in the polarisation direction over the light beam cross-section in such a way that the light mixing effected by the light mixing system produces substantially light without a polarisation preferred direction in an illumination plane. The effectively depolarising system includes at least one element of optically active crystal material with a thickness profile which varies over the light beam cross-section, wherein the optical crystal axis is substantially parallel to the light propagation direction.

In a further aspect, the invention generally features a depolarizer having a light propagation direction. The depolarizer includes at least one element of optically active crystal material with at least one portion extending substantially wedge-shaped in the light propagation direction. The optical crystal axis of the optically active crystal material is substantially parallel to the light propagation direction.

In an additional aspect, the invention generally features a depolarizer having a light propagation direction. The depolarizer includes at least one element of optically active crystal material with a thickness profile which varies over a cross-section of a light beam when the light beam impinges on the at least one element of optically active material. The optical crystal axis of the at least one element of optically active crystal material is substantially parallel to the light propagation direction.

In one aspect, the invention generally features an illumination system of a microlithographic projection exposure apparatus that includes:

a light source which produces substantially linearly polarised light which propagates along a light propagation direction;

a light mixing system; and

an effectively depolarising system which is arranged upstream of the light mixing system in the light propagation direction and which causes a variation in the polarisation direction over the light beam cross-section in such a way that the light mixing effected by the light mixing system produces substantially light without a polarisation preferred direction in an illumination plane;

wherein the effectively depolarising system has at least one element of optically active crystal material with at least one portion extending substantially wedge-shaped in the light propagation direction, wherein the optical crystal axis is substantially parallel to the light propagation direction.

The variation in the polarisation preferred direction over the light beam cross-section which is effected in the effectively depolarising system (with the aim of subsequently eliminating the polarisation preferred direction by the light mixing system, that is to say effective depolarisation) can be achieved by way of at least one element of optically active crystal material with at least one wedge-shaped portion. When light passes through that wedge-shaped portion, that involves rotation of the orientation of polarisation, such rotation being dependent on the respective passing material distance in the optically active material, wherein after light issues from the optically active material the polarisation states which are then oriented in all directions afford effectively unpolarised light upon superimposition in the illumination plane.

As the optically active crystal material is rotationally symmetrical about the optical crystal axis, along which the optical activity is operative or is utilised respectively, in accordance with the invention in particular the delicate dependency, described in the opening part of this specification, of the depolarisation effect which can be achieved or a remaining degree of residual polarisation, on the orientation of the polarisation of the linearly polarised light coming from the laser source, is avoided.

In another aspect, the invention generally features an illumination system of a microlithographic projection exposure apparatus that includes:

a light source which produces substantially linearly polarised light which propagates along a light propagation direction;

a light mixing system; and

an effectively depolarising system which is arranged upstream of the light mixing system in the light propagation direction and which causes a variation in the polarisation direction over the light beam cross-section in such a way that the light mixing effected by the light mixing system produces substantially light without a polarisation preferred direction in an illumination plane;

wherein the effectively depolarising system has at least one element of optically active crystal material with a thickness profile which varies over the light beam cross-section, wherein the optical crystal axis is substantially parallel to the light propagation direction.

In some embodiments, the effectively depolarising system has a first element with a first light entry surface formed by a planar surface in perpendicular relationship to the light propagation direction and a first light exit surface formed by at least one planar surface disposed inclinedly with respect to the light propagation direction, and a second element having a second light entry surface whose form corresponds to the first light exit surface and a second light exit surface formed by a planar surface in perpendicular relationship to the light propagation direction, wherein an element of the first and second element is made from levorotatory optically active crystal material and wherein the other element of the first and second element is made from dextrorotatory optically active crystal material.

In such an arrangement which in the simplest case corresponds to a double wedge comprising two wedge plates (of which one comprises levorotatory and one comprises dextrorotatory optically active material), it is possible to produce a larger number of depolarisation periods over the beam cross-section, that is to say for example with a predetermined laser spread, than for example when using a single wedge plate. The term ‘depolarisation period’ is used to denote, in the light beam issuing from the effectively depolarising system, the distance over the beam cross-section (that is to say in transverse relationship with the light propagation direction), after which a given orientation of the polarisation direction is repeated for the first time. In other words the depolarisation period specifies the spacing of two light beams which issue from the effectively depolarising system and in respect of which the polarisation direction is rotated through 180° relative to each other as a consequence of different material distances in the optically active material so that the same orientation of polarisation again occurs. Accordingly, pairs of orthogonal polarisation states are to be found between those beams which are spaced by the depolarisation period, at a spacing in each case of half a depolarisation period, the superimposition of those pairs of orthogonal polarisation states, by virtue of the light mixing system, affording effectively unpolarised light.

In certain embodiments, the first element and the second element are each of a substantially sawtooth-shaped thickness profile in the light propagation direction. Such an arrangement has the advantage over a ‘single’ double wedge arrangement that the number of depolarisation periods which can be produced over the beam cross-section with a predetermined laser spread can be further increased as the individual wedge-shaped portions present in the first and second elements, in comparison with a double wedge arrangement, can have respectively larger wedge angles and thus more steeply extending light entry and light exit surfaces respectively, which has the consequence of a reduction in the depolarisation period because of the length of the material distance covered, which then varies more greatly locally over the beam cross-section, and therewith the rotation of the polarisation direction.

The light exit surface of the first element and the light entry surface of the second element can in particular be in direct contact with each other. In a preferred embodiment for that purpose the first element and the second element are wrung together.

That arrangement has the advantage that total reflection cannot occur between the first and second elements so that the wedge angles which occur can even exceed the angle of total reflection, whereby it is possible to achieve larger wedge angles and thus shorter depolarisation periods.

In some embodiments, the first and the second element are respectively composed of sub-elements, which is advantageous in particular from the production engineering point of view as a consequence of an operation of wringing the elements together, which is easier to carry out.

A depolarizer, or an effectively depolarising system, is also disclosed with the features described above. Regarding preferred embodiments and advantages, reference is made to the explanations above.

Further configurations of the invention are to be found in the description and the appendant claims.

The invention is described in greater detail hereinafter by means of embodiments by way of example illustrated in the accompanying drawings.

### BRIEF DESCRIPTION OF THE DRAWINGS

In the drawings:

FIG. 1 shows a diagrammatic view of an optical system according to the invention in a first embodiment as a cross-section (FIG. 1a) and a plan view (FIG. 1b) respectively;

FIGS. 2-3 show diagrammatic views of the structure of an optical system according to the invention in accordance with further embodiments; and

FIG. 4 shows a diagrammatic view of a microlithography projection exposure apparatus in which the present invention can be embodied.

### DETAILED DESCRIPTION OF PREFERRED EMBODIMENTS

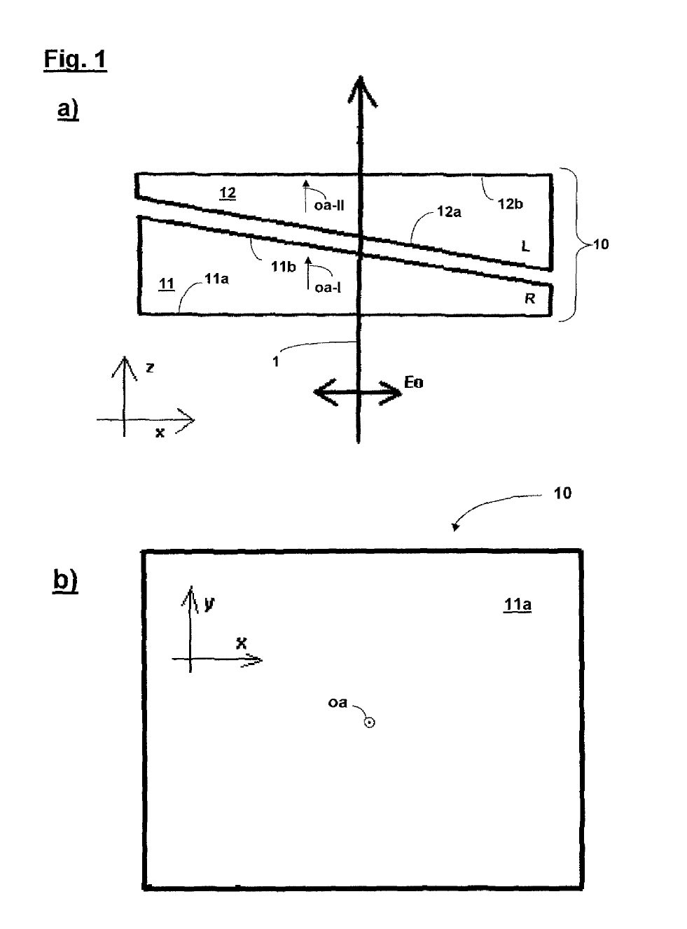

FIG. 1 shows, in an effectively depolarising optical system 10 according to the invention, a first element in the form of a first wedge plate 10 which is made from optically active material which is transparent for light of the working wavelength and which in the present embodiment comprises dextrorotatory crystalline quartz, wherein the optical axis ‘oa-I’ in the first wedge plate 11 is substantially parallel to the light propagation direction identified by ‘1’. ‘Dextrorotatory’ means here rotation of the preferred direction of polarisation of linearly polarised light in the clockwise direction when viewing from above (that is to say in the negative z-direction in accordance with the co-ordinate system specified in FIG. 1a) and is identified in FIG. 1 by ‘R’. The working wavelength is typically less than 250 nm, while preferred working wavelengths are in particular about 248 nm, 193 nm or 157 nm.

The Figure also shows a second wedge plate 12 which in the present embodiment comprises levorotatory crystalline quartz, wherein the optical crystal axis ‘oa-II’ in the second wedge plate 12 is also substantially parallel to the light propagation direction 1. ‘Levorotatory’ means here rotation of the preferred direction of polarisation of linearly polarised light in the counterclockwise direction when viewing in the negative z-direction and is identified in FIG. 1 by ‘L’.

The two wedge plates 11, 12 thus each comprise optically active material but rotate the orientation of polarisation in opposite directions. As is known, the two forms of levorotatory and dextrorotatory quartz (referred to as ‘optical isomers’ or ‘enantiomers’) admittedly contain identical molecules (SiO₂) but in mirror image relationship and can be specifically produced by suitable selection of the seed crystals. It will be appreciated that in a similar manner conversely the first wedge plate 11 can be levorotatory and the second wedge plate 12 can be dextrorotatory.

The respective light entry surfaces of the wedge plates 11, 12 are identified in FIG. 1a by 11a and 12a respectively and the respective light exit surfaces of the wedge plates are identified by 11b and 12b respectively. As shown in FIG. 1 the second wedge plate 12 is so arranged that its flat light exit surface 12b is parallel to the flat light entry surface 11a of the first wedge plate 11 and its inclined light entry surface 12a is parallel to the inclined light exit surface 11b of the first wedge plate 11 so that beam deflection of the first wedge plate 11 is compensated by the second wedge plate 12.

When using synthetic, optically active, crystalline quartz in accordance with the present embodiment, the specific rotatory power α is about 323.1° /mm at a wavelength of 193 nm and a temperature of 21.6° C. FIG. 1a indicates linearly polarised light from a light source, which is incident in the light propagation direction 1, wherein the vibration direction of the electrical field strength vector (identified by E₀) as shown in FIG. 1 in this embodiment is substantially oriented in the x-direction (without the invention being restricted thereto). In the first and the second wedge plates 11 and 12 respectively the orientation of the preferred direction of polarisation is respectively rotated in the opposite direction so that, for the light beams issuing from the light exit surface 12b of the second element 12, that involves a resulting rotation of the preferred direction of polarisation, which is dependent on the respective material distances in the first and second wedge plates 11 and 12 respectively. The light issuing from the light exit surface 12b of the second element 12 therefore embraces a plurality of locally different polarisation states, in respect of each of which the preferred direction of polarisation is oriented in different directions. If those locally different polarisation states are mixed or superimposed on passing through a subsequent light mixing system (not shown in FIG. 1) (for example a bar integrator or a suitable arrangement of microoptical elements), that superimposition affords effectively unpolarised light.

In order to achieve effective depolarisation which is as extensive as possible after mixing of the light issuing from the second wedge plate 12 it is advantageous if the number of depolarisation periods produced over the light beam cross-section is as high as possible. In the arrangement shown in FIG. 1 therefore the wedge angle in the two wedge plates 11, 12, depending on the respective spread of the light beam produced by the laser source (not shown) in the direction of the wedge configuration (that is to say in the x-direction as shown in FIG. 1) should be of such a value that a plurality of depolarisation periods occur over the entire light beam spread. In the present specific embodiment the wedge angle in the two wedge plates 11, 12 can be for example in each case 124 mrad (≈7.3°). On the basis of the specific rotatory power α of about 323.1° /mm, a material distance in the optically active crystalline quartz of about 0.56 mm is required for a 180° rotation. For a laser spread in the x-direction of x₁=40 cm, that affords a number of about 18 depolarisation periods in the illustrated double wedge arrangement.

The invention is not limited to the foregoing structure comprising at least two wedge plates of optically active material and the local variation in the polarisation direction over the light beam cross-section, which is to be achieved by the effectively depolarising optical system, can basically also be achieved with only one single wedge plate of optically active material (and a suitable compensating element to compensate for prismatic deflection). The foregoing double wedge arrangement comprising a ‘levorotatory’ and ‘dextrorotatory’ wedge however affords the advantage that, for the same predetermined laser spread, double the number of depolarisation periods can be achieved, as when using a single wedge plate.

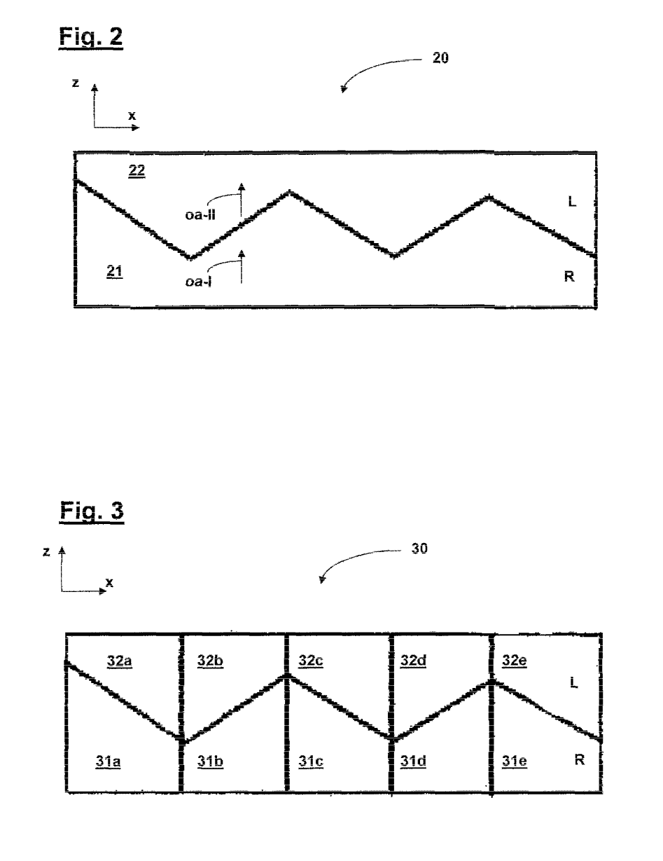

Referring now to FIG. 2 in a further preferred embodiment an effectively depolarising optical system according to the invention includes a first element 21 and a second element 22 which are of a substantially sawtooth-shaped thickness profile. Apart from that arrangement, the respective materials and the orientation of the optical crystal axis (which once again is substantially parallel to the light propagation direction) correspond to those of FIG. 1. In this arrangement therefore the first optical element 21 and the second optical element 22 each have a plurality of portions extending in a wedge shape in the z-direction (in which respect each ‘sawtooth’ can be notionally broken down into two such wedge-shaped portions). Such an arrangement has the advantage over the double wedge arrangement of FIG. 1 that the number of depolarisation periods which can be produced over the beam cross-section at a predetermined laser spread can be further increased as the individual wedge-shaped portions in the first and second elements can each be of larger wedge angles and thus have more steeply extending light entry and exit surfaces, in comparison with a double wedge arrangement. That results in a reduction in the depolarisation period because of the length, which then locally varies to a greater degree, of the material distance to be covered (in the z-direction) in the optically active material and therewith the rotation, which varies to a greater degree over the beam cross-section, of the polarisation direction.

As shown in FIG. 3, in a further embodiment of an optical system 30, to achieve the structure shown in FIG. 2 the first and the second element may also each be composed of prism-shaped sub-elements 31a-31e and 32a-32e respectively (it will be appreciated that there can be any number thereof and the number was selected only by way of example), which is advantageous in particular in terms of production engineering as a consequence of an operation of wringing the elements together being easier to carry out.

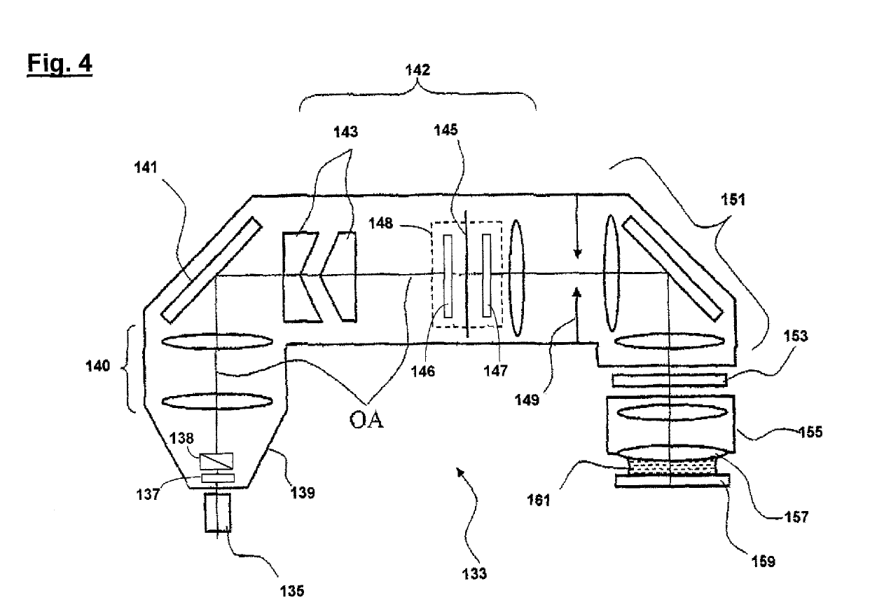

A structure by way of example of an illumination system in accordance with the invention in a microlithography projection exposure apparatus is diagrammatically described with reference to FIG. 4.

FIG. 4 is a diagrammatic view of a microlithography projection exposure apparatus 133 having a light source unit 135, an illumination system 139, a structure-bearing mask 153, a projection objective 155 and a substrate 159 to be illuminated. The light source unit 135 can include as the light source for example an ArF laser for a working wavelength of 193 nm as well as a beam-shaping optical system which produces a parallel light pencil.

In the present embodiment the parallel light pencil firstly impinges on a diffractive optical element 137. The diffractive optical element 137 produces a desired intensity distribution, for example dipole or quadrupole distribution in a pupil plane 145 by way of an angle radiation characteristic defined by the respective diffracting surface structure. The element identified by reference 138 represents an effectively depolarising system according to the invention, which in particular can be of a structure as has been described with reference to FIGS. 1-3 and which serves to produce unpolarised illumination by means of the illumination system 139. An objective 140 which follows in the beam path is designed in the form of a zoom objective which produces a parallel light pencil of variable diameter. The parallel light pencil is directed by a tilted deflection mirror 141 on to an optical unit 142 having an axicon 143. Different illumination configurations are produced in the pupil plane 145 by the zoom objective 140 in conjunction with the upstream-disposed DOE 137 and the axicon 143, depending on the respective zoom position and the position of the axicon elements. After the axicon 143, the optical unit 142 includes a light mixing system 148 which is arranged in the region of the pupil plane 145 and which in per se known manner has an arrangement of microoptical elements (represented in FIG. 4 by the elements 146 and 147), that arrangement being suitable to produce a light mixture. The optical unit 142 is followed by a reticule masking system (REMA) 149 which is projected by an REMA objective 151 on to the structure-carrying mask (reticule) 153 and thereby delimits the illuminated region on the reticule 153. The structure-bearing mask 153 is projected by a projection objective 155 on to a light-sensitive substrate 159. In the illustrated embodiment, an immersion fluid 156 with a refractive index which is different from air is disposed between a last optical element 157 of the projection objective and the light-sensitive substrate 159.

Though the invention has been described by reference to specific embodiments, numerous variations and alternative embodiments will present themselves to the man skilled in the art, for example by combination and/or exchange of features of individual embodiments. Accordingly it will be appreciated by the man skilled in the art that such variations and alternative embodiments are also embraced by the present invention and the scope of the invention is limited only in the sense of the accompanying claims and equivalents thereof.

1. An illumination system of a microlithographic projection exposure apparatus, the illumination system comprising:
a light source which produces substantially linearly polarised light which propagates along a light propagation direction;
a light mixing system; and
an effectively depolarising system,
wherein:
the effectively depolarising system is between the light source and the light mixing system along the light propagation direction;
during use of the illumination system, the effectively depolarising system causes a variation in the polarisation direction over the light beam cross-section in such a way that the light mixing effected by the light mixing system produces substantially light without a polarisation preferred direction in an illumination plane; and
the effectively depolarising system includes at least one element of optically active crystal material with at least one portion extending substantially wedge-shaped in the light propagation direction, wherein the optical crystal axis is substantially parallel to the light propagation direction.

2. An illumination system of a microlithographic projection exposure apparatus, the illumination system comprising:
a light source which produces substantially linearly polarised light which propagates along a light propagation direction;
a light mixing system; and
an effectively depolarising system,
wherein:
the effectively depolarising system is between the light source and the light mixing system along the light propagation direction;
during use of the illumination system, the effectively depolarising system causes a variation in the polarisation direction over the light beam cross-section in such a way that the light mixing effected by the light mixing system produces substantially light without a polarisation preferred direction in an illumination plane; and
the effectively depolarising system includes at least one element of optically active crystal material with a thickness profile which varies over the light beam cross-section, wherein the optical crystal axis is substantially parallel to the light propagation direction.

3. The illumination system of claim 1, wherein the element of optically active crystal material is one of the first three optical elements following the light source in the light propagation direction.

4. The illumination system of claim 1, wherein the effectively depolarising system comprises:
a first element with a first light entry surface which is formed by a planar surface in perpendicular relationship to the light propagation direction and a first light exit surface which is formed by at least one planar surface in inclined relationship with the light propagation direction; and
a second element having a second light entry surface whose form corresponds to the first light exit surface and a second light exit surface which is formed by a planar surface in perpendicular relationship to the light propagation direction,
wherein an element of the first and second elements is made from levorotatory optically active crystal material, the other element of the first and second elements is made from dextrorotatory optically active crystal material, and an optical crystal axis in the first and second elements is in each case substantially parallel to the light propagation direction.

5. The illumination system of claim 1, wherein the optically active crystal material is crystalline quartz.

6. The illumination system of claim 4, wherein the first element and the second element are each a respective wedge plate.

7. The illumination system of claim 4, wherein the first element and the second element are of a substantially sawtooth-shaped thickness profile in the light propagation direction.

8. The illumination system of claim 4, wherein the first light exit surface and the second light entry surface are in direct contact with each other.

9. The illumination system of claim 4, wherein the first element and the second element are wrung together.

10. The illumination system of claim 4, wherein the first element and the second element are each composed of a plurality of sub-elements.

11. The illumination system of claim 10, wherein sub-elements of the first element each have a light entry surface perpendicular to the light propagation direction and a light exit surface in inclined relationship with the light propagation direction, and sub-elements of the second element each have a light entry surface in inclined relationship with the light propagation direction and a light exit surface perpendicular to the light propagation direction.

12. A microlithographic projection exposure apparatus comprising the illumination system of claim 1.

13. A depolarizer having a light propagation direction, the depolarizer comprising:
at least one element of optically active crystal material with at least one portion extending substantially wedge-shaped in the light propagation direction,
wherein an optical crystal axis of the optically active crystal material is substantially parallel to the light propagation direction.

14. A depolarizer having a light propagation direction, the depolarizer comprising:
at least one element of optically active crystal material with a thickness profile which varies over a cross-section of a light beam when the light beam impinges on the at least one element of optically active material,
wherein an optical crystal axis of the at least one element of optically active crystal material is substantially parallel to the light propagation direction.

15. The depolarizer of claim 13, further comprising an effectively depolarising system that includes:
a first element with a first light entry surface which is formed by a planar surface in perpendicular relationship to the light propagation direction and a first light exit surface which is formed by at least one planar surface in inclined relationship with the light propagation direction; and
a second element having a second light entry surface whose form corresponds to the first light exit surface and a second light exit surface which is formed by a planar surface in perpendicular relationship to the light propagation direction,
wherein an element of the first and second elements is made from levorotatory optically active crystal material, and the other element of the first and second elements is made from dextrorotatory optically active crystal material, and an optical crystal axis in the first and second elements is in each case substantially parallel to the light propagation direction.

16. The illumination system of claim 2, wherein the element of optically active crystal material is one of the first three optical elements following the light source in the light propagation direction.

17. The illumination system of claim 2, wherein the effectively depolarising system comprises:
a first element with a first light entry surface which is formed by a planar surface in perpendicular relationship to the light propagation direction and a first light exit surface which is formed by at least one planar surface in inclined relationship with the light propagation direction; and
a second element having a second light entry surface whose form corresponds to the first light exit surface and a second light exit surface which is formed by a planar surface in perpendicular relationship to the light propagation direction,
wherein an element of the first and second elements is made from levorotatory optically active crystal material, the other element of the first and second elements is made from dextrorotatory optically active crystal material, and an optical crystal axis in the first and second elements is in each case substantially parallel to the light propagation direction.

18. The illumination system of claim 2, wherein the optically active crystal material is crystalline quartz.

19. A microlithographic projection exposure apparatus comprising the illumination system of claim 2.

20. The depolarizer of claim 14, further comprising an effectively depolarising system that includes:
a first element with a first light entry surface which is formed by a planar surface in perpendicular relationship to the light propagation direction and a first light exit surface which is formed by at least one planar surface in inclined relationship with the light propagation direction; and
a second element having a second light entry surface whose form corresponds to the first light exit surface and a second light exit surface which is formed by a planar surface in perpendicular relationship to the light propagation direction,
wherein an element of the first and second elements is made from levorotatory optically active crystal material, and the other element of the first and second elements is made from dextrorotatory optically active crystal material, and an optical crystal axis in the first and second elements is in each case substantially parallel to the light propagation direction.
